(19) United States
(12) Patent Application Publication
(10) Pub. No.: US 2023/0169433 A1
(43) Pub. Date: Jun. 1, 2023

(54) RULE PROCESSING APPARATUS, METHOD, AND PROGRAM

(71) Applicant: NIPPON TELEGRAPH AND TELEPHONE CORPORATION, Tokyo (JP)

(72) Inventor: Hiroshi YOSHIDA, Musashino-shi, Tokyo (JP)

(73) Assignee: NIPPON TELEGRAPH AND TELEPHONE CORPORATION, Tokyo (JP)

(21) Appl. No.: 17/921,086

(22) PCT Filed: Apr. 30, 2020
(86) PCT No.: PCT/JP2020/018274

§ 371 Date: Oct. 24, 2022

(51) Int. Cl. G06Q 10/0635

(52) U.S. Cl. CPC G06Q 10/0635

(57) ABSTRACT

A rule processing apparatus according to an embodiment has: an evaluation unit that evaluates, by comparing a plurality of business data with a first rule used for evaluating whether business data is appropriate or not and a second rule used for evaluating whether the business data is inappropriate or not, whether or not the business data conforms to the first or second rule for each business data, and thereby evaluates whether the business data is appropriate or not; a second calculation unit that calculates the proportion of the number of business data conforming to the first or second rule to the total number of the business data and a ratio that is based on the number of business data evaluated as conforming to the first rule and the number of business data evaluated as conforming to the second rule based on an evaluation result; and a determination unit that determines that the first or second rule needs to be increased or decreased in number based on the rule hit rate and the ratio.

### TECHNICAL FIELD

Embodiments of the present invention relate to a rule processing apparatus, method, and program.

### BACKGROUND ART

There is a technique in which, for collected business data, rules (policy) are applied to the content of each business data using a tool or the like, thereby determining whether the business data conforms to the rules (see, e.g., Non-Patent Literature 1).

### CITATION LIST

### Non-Patent Literature

Non-Patent Literature 1: Business Rule Management System (BRMS)
https://www.ibm.com/developerworks/jp/websphere/library/i log/brms_intro/index.html

### SUMMARY OF THE INVENTION

### Technical Problem

However, it is necessary to manually adopt or reject rules to be used for such determination at present, so the establishment or improvement of rules requires certain skills of the administrator of the rules. Further, certain maintenance work for the rules is required.

The present invention has been made by focusing on the above circumstances, and an object of the present invention is to provide a rule processing apparatus, method, and program capable of contributing to the improvement of rules for business data.

### Means for Solving the Problem

A rule processing apparatus according to an aspect of the present invention includes: an evaluation unit that evaluates, by comparing a plurality of business data to be evaluated with at least one first rule that is at least one rule used for evaluating whether business data is appropriate or not and at least one second rule that is at least one rule used for evaluating whether the business data is inappropriate or not that are stored in a storage apparatus in which the first and second rules are stored, whether or not the business data conforms to the first or second rule for each business data, and evaluates whether the business data is appropriate or not based on a result of the evaluation; a first calculation unit that calculates a rule hit rate that is the proportion of the number of business data conforming to the first or second rule to the total number of the business data based on an evaluation result obtained by the evaluation unit; a second calculation unit that calculates a ratio that is based on the number of business data evaluated by the evaluation unit as conforming to the first rule among the plurality of business data to be evaluated and the number of business data evaluated by the evaluation unit as conforming to the second rule among the plurality of business data to be evaluated; and a determination unit that determines that the first or second rule needs to be increased or decreased in number based on the rule hit rate calculated by the first calculation unit and the ratio calculated by the second calculation unit.

A rule processing method according to an aspect of the present invention includes: evaluating, by comparing a plurality of business data to be evaluated with at least one first rule that is at least one rule used for evaluating whether business data is appropriate or not and at least one second rule that is at least one rule used for evaluating whether the business data is inappropriate or not that are stored in a storage apparatus in which the first and second rules are stored, whether or not the business data conforms to the first or second rule for each business data, and evaluating whether the business data is appropriate or not based on a result of the evaluation; calculating a rule hit rate that is the proportion of the number of business data conforming to the first or second rule to the total number of the business data based on a result of the evaluation; calculating a ratio that is based on the number of the business data evaluated as conforming to the first rule among the plurality of business data to be evaluated and the number of the business data evaluated as conforming to the second rule among the plurality of business data to be evaluated; and determining that the first or second rule needs to be increased or decreased in number based on the calculated rule hit rate and the calculated ratio.

### Effects of the Invention

According to the present invention, it is possible to contribute to the improvement of rules for business data.

### BRIEF DESCRIPTION OF DRAWINGS

FIG. 1 is a block diagram showing an example of application of a rule processing apparatus according to an embodiment of the present invention.

FIG. 2 is a diagram showing an example of business data in a table format.

FIG. 3 is a diagram showing an example of an OK rule in evaluation rules in a table format.

FIG. 4 is a diagram showing an example of an NG rule in evaluation rules in a table format.

FIG. 5 is a diagram showing configurations of an evaluation rule and a matching (comparing) element as an ER diagram (entity relationship diagram).

FIG. 6 is a flow chart showing an example of a processing procedure performed by the rule processing apparatus.

FIG. 7 is a diagram showing an example of business data to be evaluated in a table format.

FIG. 8 is a diagram showing an example of an evaluation result of business data.

FIG. 9 is a diagram showing an example of a sampling result for evaluated business data.

FIG. 10 is a diagram showing an example of an evaluation result of evaluated business data and a determined evaluation result.

FIG. 11 is a diagram showing an example of a result of counting the number of rule errors for evaluation rules.

FIG. 12 is a diagram showing an example of determination as to addition or deletion of evaluation rules in a table format.

FIG. 13 is a diagram showing an example of evaluation rules including rule evaluation values in a table format.

FIG. 14 is a diagram showing an example of an existing OK rule used for addition of an OK rule in a table format.

FIG. 15 is a diagram showing an example of an OK rule to be added in a table format.

FIG. 16 is a diagram showing an example of an OK rule to be deleted in a table format.

FIG. 17 is a block diagram showing an example of a hardware configuration of the rule processing apparatus according to an embodiment of the present invention.

### DESCRIPTION OF EMBODIMENTS

Hereinafter, an embodiment according to this invention will be described with reference to the drawings.

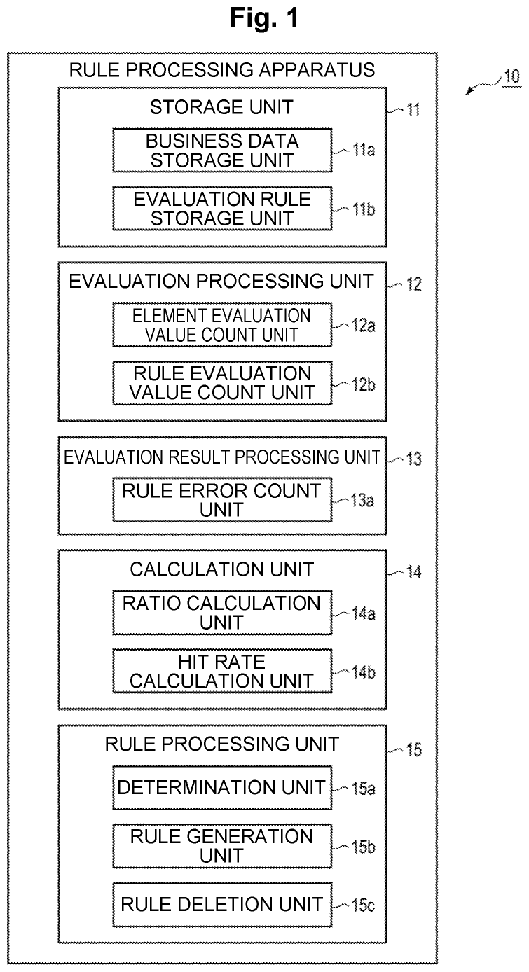

FIG. 1 is a block diagram showing an example of application of a rule processing apparatus according to an embodiment of the present invention.

As shown in FIG. 1, a rule processing apparatus 10 according to an embodiment of the present invention includes a storage unit 11, an evaluation processing unit 12, an evaluation result processing unit 13, a calculation unit 14, and a rule processing unit 15.

The storage unit 11 has a business data storage unit 11a and an evaluation rule storage unit 11b.

The evaluation processing unit 12 has an element evaluation value count unit 12a and a rule evaluation value count unit 12b.

The evaluation result processing unit 13 has a rule error count unit 13a.

The calculation unit 14 has a ratio calculation unit 14a and a hit rate calculation unit 14b.

The rule processing unit 15 has a determination unit 15a, a rule generation unit 15b, and a rule deletion unit 15c.

(Business Data)

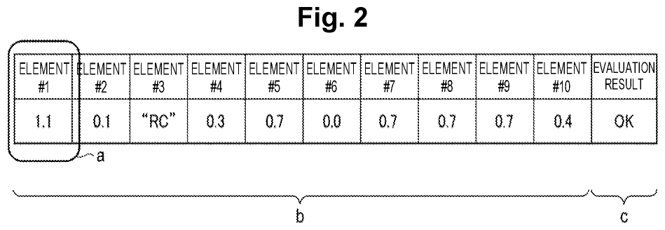

FIG. 2 is a diagram showing an example of business data in a table format.

The business data storage unit 11a stores a plurality of business data including the business data as shown in FIG. 2.

As shown in FIG. 2, the business data can be represented as a vector and includes data for a plurality of elements. The business data shown in FIG. 2 includes data for ten elements from “element #1” to “element #10”. The data for each element is, for example, a character string or a numerical value. In this embodiment, this business data is an evaluation target as to whether the content of the business data is appropriate or not.

(Evaluation Rule)

The evaluation rule storage unit 11b stores evaluation rules used for evaluating whether the content of business data is appropriate or not.

The evaluation rules for business data are classified into OK rules (first rules) and NG rules (second rules).

An OK rule is a rule that gives an evaluation result of “OK” to business data when the business data conforms only to the OK rule.

An NG rule is a rule that gives an evaluation result of “NG” to business data when the business data conforms only to the NG rule. Further, when business data conforms to an OK rule and an NG rule, an evaluation result is given to the business data based on the determination described later.

The business data shown in FIG. 2 includes data (the value of business data) for each element. The business data shown in FIG. 2 has data for each element including data “1.1” for “element #1” and data “RC” for “element #3”.

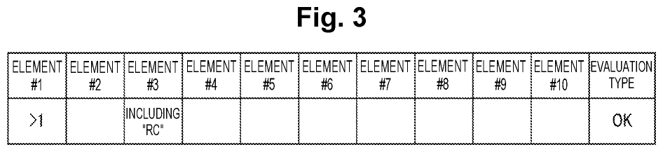

FIG. 3 is a diagram showing an example of an OK rule in evaluation rules in a table format.

The OK rule shown in FIG. 3 includes an evaluation rule for each element of business data. The example shown in FIG. 3 has a rule value of “>1” for “element #1” and a rule value of “including ‘RC’” for “element #3”. The value for each element of the evaluation rule includes a character string or a numerical value. In the OK rule shown in FIG. 3, the rule values for the other elements are wild cards and are shown as blanks.

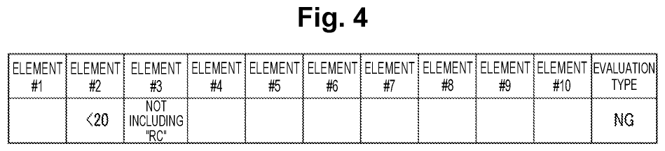

FIG. 4 is a diagram showing an example of an NG rule in evaluation rules in a table format.

The NG rule shown in FIG. 4 includes an evaluation rule for each element of business data. The example shown in FIG. 4 has a rule value of “<1” for “element #2” and a rule value of “not including ‘RC’” for “element #3”. In the NG rule shown in FIG. 4, the rule values for the other elements are wild cards and are shown as blanks.

(Evaluation for Business Data)

The data of each element of business data is compared by the evaluation processing unit 12 with the rule value of the corresponding element in an OK rule. For example, the data of “element #1” of the business data shown in FIG. 2 is compared with the rule value of “element #1” of the OK rule shown in FIG. 3. When there are a plurality of OK rules, the business data is compared with the rule value of the corresponding element in each of the OK rules.

As a result of the comparison, when the data of all the elements of the business data conform to the rule values of the corresponding elements in the compared OK rule, the business data is evaluated as conforming to the compared OK rule. On the other hand, as a result of the comparison, when the data of at least one element of the business data does not conform to the rule value of the corresponding element in the OK rule, the business data is evaluated as not conforming to the compared OK rule.

When the data (“a” in FIG. 2) for the element “#1” of the business data shown in FIG. 2 is to be compared with each rule, the data “1.1” for the element “#1” of the business data conforms to the rule value “>1” for the corresponding element “#1” in the OK rule shown in FIG. 3. Further, the data “RC” for the element “#3” of the business data conforms to the rule value “including ‘RC’” for the corresponding element “#3” in the OK rule.

When the data of an element of business data is compared with the rule value “wild card” of the corresponding element in an OK rule, the OK rule of the business data is evaluated as conforming to the compared OK rule. The same applies when the data of an element of the business data is compared with the rule value “wild card” of the corresponding element in the NG rule.

As a result, the data for all the elements “#1” to “#10” of the business data shown in FIG. 2 conform to the rule values of the elements in the OK rule for comparison shown in FIG. 3 (“b” in FIG. 2).

Thus, the business data shown in FIG. 2 is evaluated as conforming to the OK rule shown in FIG. 3. The evaluation type “OK” shown in FIG. 3 (“c” in FIG. 2) indicates that the business data shown in FIG. 2 conforms to the OK rule shown in FIG. 3.

Further, the data of each element of the business data is compared by the evaluation processing unit 12 with the rule value of the corresponding element in the NG rule. For example, the data of “element #1” of the business data shown in FIG. 2 is compared with the rule of “element #1” of the NG rule shown in FIG. 4. When there are a plurality of NG rules, the business data is compared with the rule value of the corresponding element in each of the NG rules.

As a result of the comparison, when the data of all the elements of the business data conform to the rule values of the corresponding elements in the compared NG rule, the business data is evaluated as conforming to the compared NG rule. On the other hand, as a result of the comparison, when the data of at least one element of the business data does not conform to the rule value of the corresponding element in the NG rule, the business data is evaluated as not conforming to the compared NG rule.

The data “RC” for the element “#3” of the business data shown in FIG. 2 does not conform to the rule value “not including ‘RC’” for the corresponding element “#3” in the NG rule shown in FIG. 4.

Thus, the business data shown in FIG. 2 is evaluated as not conforming to the NG rule shown in FIG. 4. The evaluation type “NG” shown in FIG. 4 indicates that the business data shown in FIG. 2 does not conform to the NG rule shown in FIG. 4.

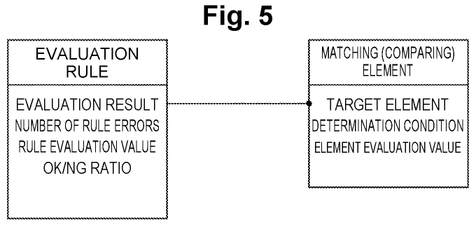

FIG. 5 is a diagram showing configurations of an evaluation rule and a matching element as an ER diagram.

As shown in FIG. 5, an evaluation rule and a matching element constituting the evaluation rule may be illustrated as an ER diagram. The ER diagram shown in FIG. 5 is drawn using IDEF1X (Integration DEFinition for information modeling) notation.

In the example shown in FIG. 5, the evaluation rule corresponds to a parent entity, and the matching element corresponds to a child entity. Here, the parent entity and the child entity have a relationship of one to zero or more.

The primary key of the attribute in the parent entity shown in FIG. 5 is “evaluation rule”. Further, foreign keys for this attribute are “evaluation result”, “number of rule errors”, “rule evaluation value”, and “OK/NG ratio”.

The primary key of the attribute in the child entity shown in FIG. 5 is “evaluation rule”, and foreign keys are “target element”, “determination condition”, and “element evaluation value”.

“Target element” is, for example, “element #1” of the OK rule shown in FIG. 3, and “determination condition” is, for example, the rule value “>1” for “element #1” of the OK rule shown in FIG. 3. The element evaluation value will be described later.

Next, the terms used in this embodiment will be described.

Rule Evaluation Value

A rule evaluation value is the total number obtained by counting, for each compared rule, the number of times business data is evaluated as conforming to the compared evaluation rule by the rule evaluation value count unit 12b of the evaluation processing unit 12. When there are a plurality of OK rules, the rule evaluation value is counted for each of the OK rules. The same applies when there are a plurality of NG rules.

The rule evaluation value of each rule is incremented by 1 and updated each time business data is evaluated as conforming to each rule as a result of comparison with the business data by the evaluation processing unit 12.

The rule evaluation value of each rule is cleared, for example, through a reset operation made by the administrator.

Number of Rule Errors

The number of rule errors is the number of errors counted by the rule error count unit 13a of the evaluation result processing unit 13 for a compared rule when the evaluation result of business data obtained by comparing the business data with the evaluation rule is determined by an expert as an error.

Cases where the evaluation result of the business data is determined by the expert as an error include a case where this evaluation result is determined by the expert as “NG” when the evaluation result of the business data is “OK” and a case where this evaluation result is determined by the expert as “OK” when the evaluation result of the business data is “NG”.

The number of rule errors for each rule is updated by evaluation result processing described later.

The number of rule errors for each rule is cleared through a reset operation.

Element Evaluation Value

An element evaluation value is a value obtained by counting the number of matches for each element by the element evaluation value count unit 12a of the evaluation processing unit 12 regardless of whether or not all the elements of business data have finally matched their corresponding elements in the evaluation rule when the business data is compared with the evaluation rule.

The element evaluation value of each element of each evaluation rule is updated each time the rule value for the element is compared with the data of the corresponding element in the business data to be evaluated.

When the rule value for an element in the evaluation rule is blank, that is, when it is a wild card, 1 is added to the element evaluation value each time a comparison is made.

The element evaluation value of each element of each evaluation rule is cleared through a reset operation.

OK/NG Ratio

When the evaluation results of “A” pieces of business data are “OK” and the evaluation results of “B” pieces of business data are “NG” as a result of comparing a certain amount of (X pieces of) business data such as ones for one day or for one month with each evaluation rule, the result calculated as A/B by the ratio calculation unit 14a of the calculation unit 14 is defined as “OK/NG ratio”. This OK/NG ratio may be calculated again when the set of business data is changed. This OK/NG ratio is cleared through a reset operation.

Rule Hit Rate

It is assumed that, for example, the following conditions (1) to (3) are satisfied as a result of comparing the certain amount of (X pieces of) business data described above with each evaluation rule.

(1) By comparing business data X1 in the X pieces of business data with each OK rule and each NG rule, the business data X1 conforms to A1 OK rules and B1 NG rules.

(2) By comparing business data X2 in the X pieces of business data with each OK rule and each NG rule, the business data X2 conforms to A2 OK rules and B2 NG rules.

(3) By comparing business data X3 in the X pieces of business data with each OK rule and each NG rule, the business data X3 conforms to A3 OK rules and B3 NG rules.

The result calculated by the hit rate calculation unit 14b of the calculation unit 14 according to the following expression (1) using “(A1+A2+A3)+(B1+B2+B3)” as the numerator and “(X1+X2+X3)” as the denominator when the above conditions (1) to (3) are satisfied is defined as “rule hit rate”.

The rule hit rate is cleared through a reset operation.

Guiding OK/NG Ratio

It is necessary to add OK rules and NG rules while maintaining their balance in the process of setting evaluation rules for each of various business data.

For example, when there are too many OK rules, business data is evaluated as “OK” though it should originally be evaluated as “NG”. As a result, this becomes a factor of deterioration in business quality.

Further, when there are too many NG rules, business data is evaluated as “NG” though it should originally be evaluated as “OK”. As a result, the work for confirming the business contents is unnecessarily increased.

Therefore, a guiding OK/NG ratio that is a fixed value is defined in advance as an appropriate OK/NG ratio, and the above calculated OK/NG ratio is made closer (guided) to this guiding OK/NG ratio, thereby adding OK rules and NG rules while maintaining the above balance.

As a method of setting this guiding OK/NG ratio, it is conceivable to refer to the OK/NG ratio calculated for other business data for which rules have already been established completely.

Guiding Rule Hit Rate

When there are too many evaluation rules, the work for confirming the business contents increases, and the efficiency of the business worsens conversely.

Further, when there are too few evaluation rules, the effect of evaluating business data using evaluation rules lowers.

Therefore, a guiding rule hit rate that is a fixed value is defined in advance as an appropriate rule hit rate, and the above calculated rule hit rate is made closer to this guiding rule hit rate, thereby making the numbers of OK rules and NG rules appropriate.

As a method of setting this guiding rule hit rate, it is conceivable to refer to the rule hit rate calculated for other business data for which rules have already been established completely.

Next, a processing procedure performed by the rule processing apparatus will be described.

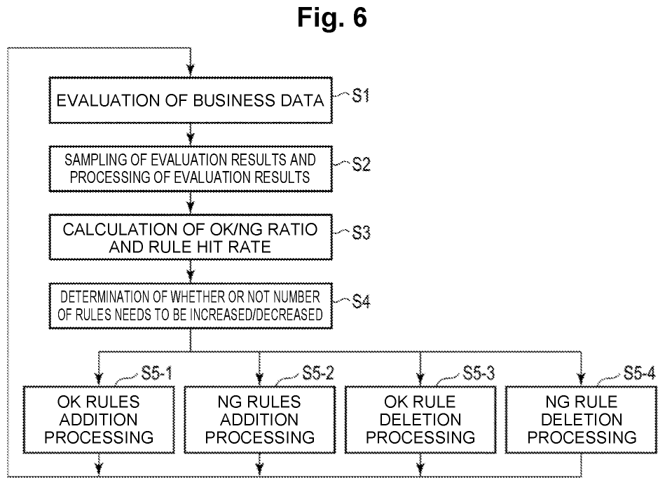

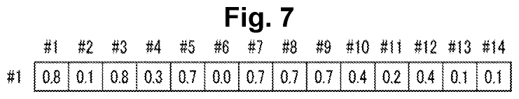

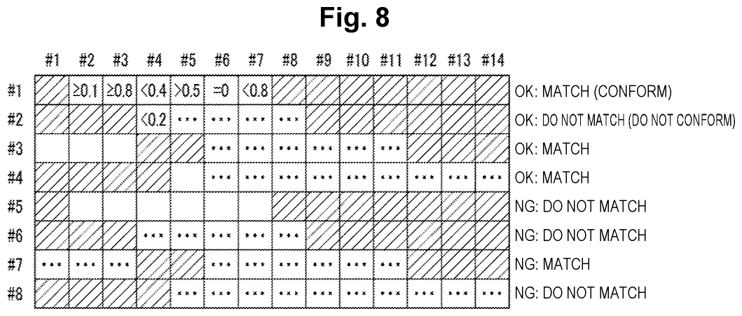

FIG. 6 is a flow chart showing an example of a processing procedure performed by the rule processing apparatus. FIG. 7 is a diagram showing an example of business data to be evaluated in a table format. FIG. 8 is a diagram showing an example of an evaluation result of business data.

FIG. 7 shows the data of each element from the elements “#1” to “#14” of the business data “#1”. FIG. 8 shows the rule value of each element in four OK rules “#1” to “#4” and four NG rules “#5” to “#8”. Wild cards of the rule values shown in FIG. 8 such as the rule values of the element “#1” and the elements “#8” to “#14” of the OK rule “#1” are shown shaded.

Evaluation of Business Data (S11)

First, the evaluation processing unit 12 performs matching (comparison) of business data stored in the business data storage unit 11a with evaluation rules stored in the evaluation rule storage unit 11b.

When the data of each element of the compared business data matches the rule value of the corresponding element in the compared OK rule, the evaluation processing unit 12 considers that the compared business data conforms to the compared OK rule and gives an evaluation result of “OK” to the business data.

Further, when the data of each element of the compared business data matches the rule value of the corresponding element in the compared NG rule, the evaluation processing unit 12 considers that the compared business data conforms to the compared NG rule and gives an evaluation result of “NG” to the business data.

When there are a plurality of evaluation rules, the above comparison is performed for each evaluation rule. Further, when the rule in the evaluation rule is a wild card in the comparison, the evaluation processing unit 12 considers that the business data matches the rule value of the corresponding element.

When there are a plurality of evaluation rules and the number of OK rules that business data matches (conforms to) is larger than the number of matched NG rules as a result of the above comparison, the evaluation processing unit 12 determines that the evaluation result of the business data is “OK”, that is, the content of the business data is appropriate.

Further, when the number of OK rules that business data matches is smaller than or equal to the number of matched NG rules as a result of the above comparison, the evaluation processing unit 12 determines that the evaluation result of the business data is “NG”, that is, that the content of the business data is inappropriate.

Further, when business data does not match any evaluation rule as a result of the above comparison, the evaluation processing unit 12 determines that the evaluation result of the business data is “pending”.

(Counting Element Evaluation Value and Rule Evaluation Value)

After the above comparison has been made, the element evaluation value is counted by the element evaluation value count unit 12a of the evaluation processing unit 12 and the rule evaluation value is counted by the rule evaluation value count unit 12b of the evaluation processing unit 12 irrespective of the evaluation result of the business data.

For example, when the business data “#1” shown in FIG. 7 is compared with four OK rules “#1” to “#4” shown in FIG. 8 and four NG rules “#5” to “#8” shown in FIG. 8, the data of each element of the business data “#1” conforms to the rule value of each element of the OK rules “#1”, “#3”, and “#4” and the NG rule “#7” shown in FIG. 8.

“Match (conform)”, which is put down with the OK rules “#1”, “#3”, and “#4” and the NG rule “#7” shown in FIG. 8, indicates that the rule conforms to the business data “#1” shown in FIG. 7.

Further, the data of each element of the business data “#1” shown in FIG. 7 does not conform to the rule value of each element of the OK rule “#2” and the NG rules “#5”, “#6”, and “#8” shown in FIG. 8.

“Do not match”, which is put down with the OK rule “#2” and the NG rules “#5”, “#6”, and “#8” shown in FIG. 8, indicates that the rule does not conform to the business data “#1” shown in FIG. 7.

In the example shown in FIGS. 7 and 8, the number of OK rules that conform to the business data “#1” is three, and the number of NG rules that conform to the business data “#1” is one.

As a result, since the number of OK rules that conform to the business data “#1” is greater than the number of NG rules that conform to the business data “#1”, the evaluation processing unit 12 evaluates the business data “#1” as conforming to the evaluation rules shown in FIG. 8 and gives an evaluation result of “OK” to this business data “#1”.

Processing of Evaluation Results (S2)

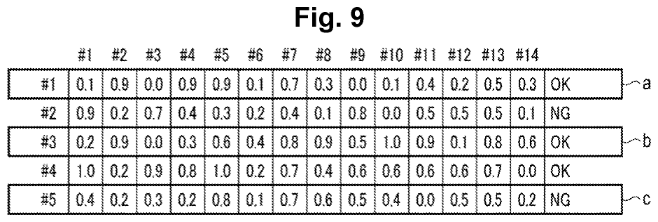

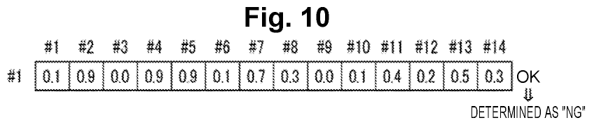

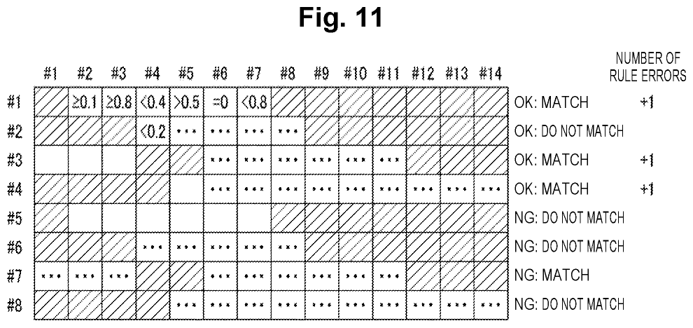

FIG. 9 is a diagram showing an example of a sampling result for evaluated business data. FIG. 10 is a diagram showing an example of an evaluation result of evaluated business data and a determined evaluation result. FIG. 11 is a diagram showing an example of a result of counting the number of rule errors for evaluation rules.

(Counting the Number of Rule Errors)

The evaluation result processing unit 13 presents all business data for which the evaluation results obtained by the evaluation processing unit 12 are “OK” or “NG” or business data randomly sampled in any proportion to an expert by, for example, displaying them on a display, and the expert's determination result as to whether the evaluation results are appropriate or not is input.

In the example shown in FIG. 9, the business data “#1” (“a” in FIG. 9), “#3” (“b” in FIG. 9), and “#5” (“c” in FIG. 9) of the business data “#1”, “#3”, and “#4” for which the evaluation results are “OK” and the business data “#2” and “#5” for which the evaluation results are “NG” are sampled by the evaluation result processing unit 13 and applied to the subsequent processing.

When the input determination result indicates that the evaluation result for business data obtained by the evaluation processing unit 12 is not appropriate, the rule error count unit 13a of the evaluation result processing unit 13 counts the number of rule errors as described below.

First, when the expert's determination result is input which indicates that the evaluation result “OK” for business data obtained by the evaluation processing unit 12 is not appropriate but “NG” is appropriate as the evaluation result, the rule error count unit 13a counts the number “1” of rule errors for all the OK rules that match the business data as a result of comparison with the business data, and associates it with those OK rules.

Secondly, when the expert's determination result is input which indicates that the evaluation result “NG” for business data obtained by the evaluation processing unit 12 is not appropriate but “OK” is appropriate as the evaluation result, the rule error count unit 13a counts the number “1” of rule errors for all the NG rules that match the business data as a result of comparison with the business data, and associates it with those NG rules.

Although the evaluation result for the business data “#1” is “OK” in the example shown in FIGS. 10 and 11, when the expert's determination result is input which indicates that an evaluation result of “NG” is appropriate as the evaluation result for the business data “#1”, the number “1” of rule errors is counted for the OK rules “#1”, “#3”, and “#4” evaluated as conforming to the business data “#1”.

As another example, when the evaluation result for another business data is “NG” but the expert's determination result is input which indicates that an evaluation result of “OK” is appropriate as the evaluation result for this business data, the number “1” of rule errors is counted for the NG rule “#3” evaluated as conforming to the business data “#1”.

Calculation of OK/NG Ratio and Rule Hit Rate (S3)

After the evaluation results for a certain number of business data are obtained, the OK/NG ratio is calculated by the ratio calculation unit 14a of the calculation unit 14, and the rule hit rate is calculated by the hit rate calculation unit 14b of the calculation unit 14.

Determination of Whether or Not the Number of Rules Needs to Be Increased/Decreased (S4)

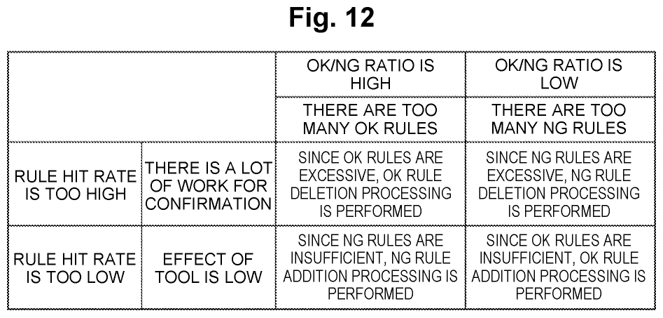

FIG. 12 is a diagram showing an example of determination as to addition or deletion of evaluation rules in a table format.

After the OK/NG ratio and the rule hit rate are calculated, the determination unit 15a of the rule processing unit 15 performs determinations shown in (1) to (4) below according to the values of the OK/NG ratio, the guiding OK/NG ratio, the rule hit rate, and the guiding rule hit rate in accordance with the conditions shown in FIG. 12. The guiding OK/NG ratio and the guiding rule hit rate are stored in advance in, for example, the storage unit 11.

(1) When the condition that “OK/NG ratio guiding OK/NG ratio and rule hit rate≤guiding rule hit rate” is satisfied, the determination unit 15a determines that the OK rules are insufficient and therefore the number of OK rules needs to be increased.

(2) When the condition that “OK/NG ratio>guiding OK/NG ratio and rule hit rate guiding rule hit rate” is satisfied, the determination unit 15a determines that the NG rules are insufficient and therefore the number of NG rules needs to be increased.

(3) When the condition that “OK/NG ratio>guiding OK/NG ratio and rule hit rate >guiding rule hit rate” is satisfied, the determination unit 15a determines that the OK rules are excessive and therefore the number of OK rules needs to be decreased.

(4) When the condition that “OK/NG ratio≥guiding OK/NG ratio and rule hit rate>guiding rule hit rate” is satisfied, the determination unit 15a determines that the NG rules are excessive and therefore the number of NG rules needs to be decreased.

The rule generation unit 15b performs the following OK rule addition processing or NG rule addition processing according to the determination result obtained by the determination unit 15a.

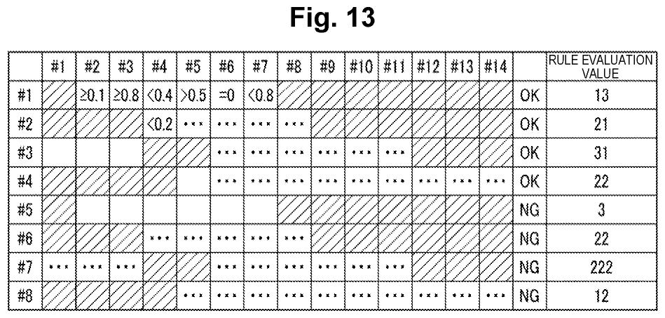

FIG. 13 is a diagram showing an example of evaluation rules including rule evaluation values in a table format.

The rule evaluation value for each rule shown in FIG. 13 is a value counted by the rule evaluation value count unit 12b.

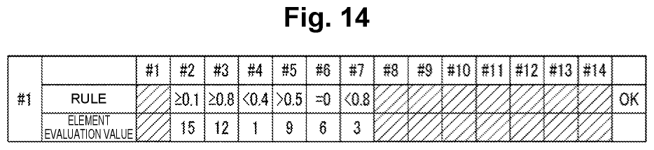

FIG. 14 is a diagram showing an example of an existing OK rule used for addition of an OK rule in a table format.

The element evaluation values for the OK rule “#1” shown in FIG. 14 are values counted by the element evaluation value count unit 12a. Note that illustration of the element evaluation values for each rule is omitted in FIG. 13.

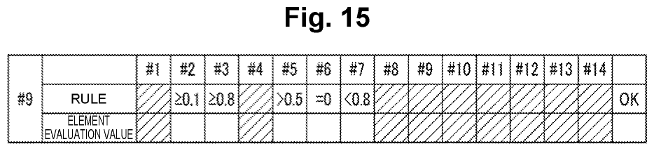

FIG. 15 is a diagram showing an example of an OK rule to be added in a table format.

OK Rule Addition Processing (S5-1) The rule generation unit 15b generates a new OK rule based on the OK rule having the lowest rule evaluation value among the OK rules, that is, an OK rule to which the compared business data less frequently conform.

Specifically, the rule generation unit 15b duplicates the rule value and the element evaluation value of each element of the OK rule having the lowest rule evaluation value described above as the base for the new OK rule.

The rule generation unit 15b replaces the rule value of the element with the lowest element evaluation value in the duplicated result with a wild card. With this replacement, the element evaluation value of the element has no setting.

For example, the rule generation unit 15b identifies the OK rule “#1” having the lowest rule evaluation value among the OK rules “#1” to “#4” shown in FIG. 13, and uses this rule as the base for the new OK rule as shown in FIG. 14.

Then, the rule generation unit 15b identifies the element “#4” having the lowest element evaluation value among the elements in the rule shown in FIG. 14, changes the rule value of this element to a wild card to generate a rule in which the setting of the element evaluation value is removed as a new OK rule “#9” as shown in FIG. 15, and stores it in the evaluation rule storage unit 11b.

NG Rule Addition Processing (S5-2)

The rule generation unit 15b generates a new NG rule based on the NG rule having the lowest rule evaluation value among the NG rules, that is, an NG rule to which the compared business data less frequently conform.

Specifically, the rule generation unit 15b duplicates the rule value and the element evaluation value of each element of the NG rule having the lowest rule evaluation value described above as the base for the new NG rule.

The rule generation unit 15b replaces the rule value of the element with the lowest element evaluation value in the duplicated result with a wild card. With this replacement, the element evaluation value of the element has no setting.

OK Rule Deletion Processing (S5-3)

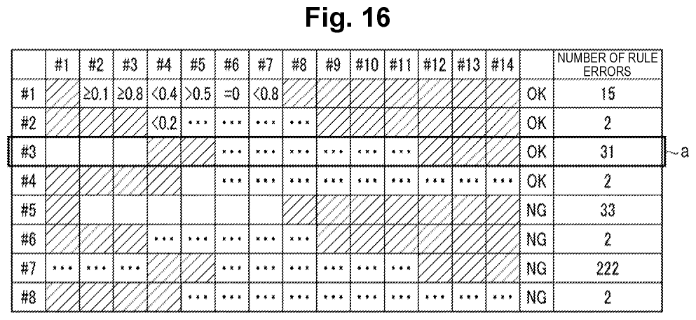

FIG. 16 is a diagram showing an example of an OK rule to be deleted in a table format.

The number of rule errors for each rule shown in FIG. 16 is a value counted by the rule error count unit 13a.

The rule deletion unit 15c deletes the OK rule having the largest number of rule errors among the OK rules, that is, an OK rule having a high possibility of being a factor that causes an expert to more often determine that the evaluation result of business data is not appropriate.

NG Rule Deletion Processing (S5-4)

The rule deletion unit 15c deletes the NG rule having the largest number of rule errors among the NG rules, that is, an NG rule having a high possibility of being a factor that causes an expert to more often determine that the evaluation result of business data is not appropriate.

Specifically, the rule deletion unit 15c deletes the OK rule “#3” (“a” in FIG. 16) having the largest number of rule errors among the OK rules shown in FIG. 16.

Reset Processing

The rule processing unit 15 can set the number of rule errors, the rule evaluation value, and the element evaluation values to zero for all the rules according to an input operation made by the user or the like.

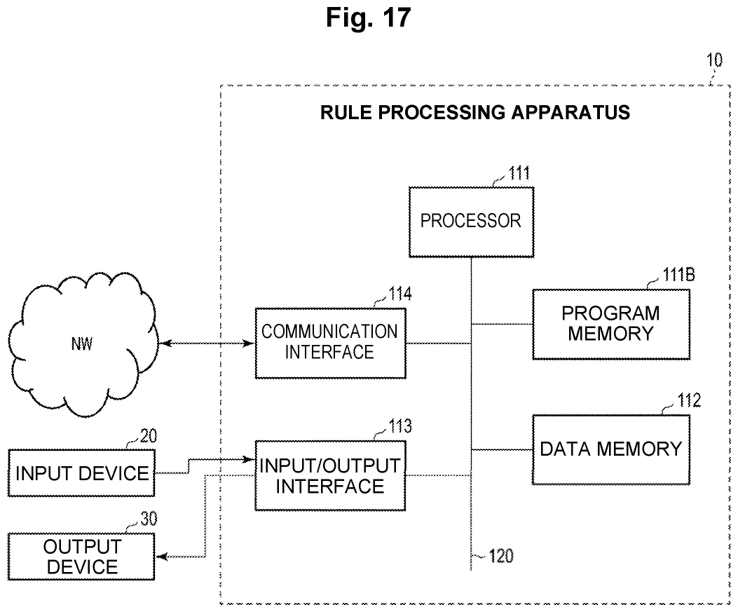

FIG. 17 is a block diagram showing an example of a hardware configuration of the rule processing apparatus according to an embodiment of the present invention.

In the example shown in FIG. 17, the rule processing apparatus 10 according to the above embodiment is composed of, for example, a server computer or a personal computer, and has a hardware processor 111A such as a CPU. Then, a program memory 111B, a data memory 112, an input/output interface 113, and a communication interface 114 are connected to this hardware processor 111A via a bus 120.

The communication interface 114 includes, for example, one or more wireless communication interface units, and enables transmission/reception of information to/from a communication network NW. As the wireless interface, an interface is used that employs a low-power wireless data communication standard such as wireless LAN (local area network).

An input device 20 and an output device 30 for an operator that are attached to the rule processing apparatus 10 are connected to the input/output interface 113.

The input/output interface 113 captures operation data input by the operator through the input device 20 such as a keyboard, a touch panel, a touchpad, or a mouse, and performs processing for outputting output data to the output device 30 including a display device using liquid crystal, organic EL (electro luminescence), or the like and displaying it thereon. Note that devices built in the rule processing apparatus 10 may be used for the input device 20 and the output device 30, or an input device and an output device of another information terminal capable of communicating with the rule processing apparatus 10 via the network NW may also be used.

The program memory 111B is, for example, one in which a non-volatile memory to/from which writing/reading can be performed at any time such as an HDD (hard disk drive) or an SD (solid state drive) and a non-volatile memory such as a ROM (read only memory) are used in combination as a non-transitory tangible storage medium, and stores a program necessary for executing various types of control processes according to an embodiment.

The data memory 112 is, for example, one in which the non-volatile memories described above and a volatile memory such as a RAM (random access memory) are used in combination as a tangible storage medium, and is used to store various types of data acquired and created in the process of performing various types of processes.

The rule processing apparatus 10 according to an embodiment of the present invention may be configured as a data processing apparatus having the storage unit 11, the evaluation processing unit 12, the evaluation result processing unit 13, the calculation unit 14, and the rule processing unit 15 shown in FIG. 1 as processing function units by software.

The storage unit 11 may be configured with the data memory 112 shown in FIG. 17. However, these areas are not essential components in the rule processing apparatus 10, but may be areas provided in, for example, an external storage medium such as a USB (universal serial bus) memory or a storage apparatus such as a database server located in the cloud.

Any of the processing function units in each unit of the evaluation processing unit 12, the evaluation result processing unit 13, the calculation unit 14, and the rule processing unit 15 described above may be implemented by causing the above hardware processor 111A to read and execute a program stored in the program memory 111B. Note that some or all of these processing function units may be implemented in various other forms including integrated circuits such as an ASIC (application specific integrated circuit) or an FPGA (field-programmable gate array).

As described above, the rule processing apparatus according to an embodiment of the present invention compares business data with evaluation rules to obtain an evaluation result for the business data, calculates the rule hit rate and the OK/NG ratio based on this evaluation result, and determines whether or not the number of evaluation rules needs to be increased or decreased based on these calculation results, so it is possible to contribute to the improvement of rules for business data.

Further, the approach described in each embodiment may be distributed as a program (software means) executable by a computer by storing it in a recording medium such as a magnetic disk (floppy (R) disk, hard disk, etc.), an optical disc (CD-ROM, DVD, MO, etc.), or a semiconductor memory (ROM, RAM, flash memory, etc.), or transmitting it via a communication medium. Note that programs stored on the side of the medium also include a setting program for causing software means to be executed by a computer (including not only the execution program but also tables and data structures) to be built in the computer. The computer that implements this apparatus executes the processing described above by reading the programs recorded in the recording medium, building the software means using the setting program in some cases, and having the operation controlled by this software means. Note that a recording medium as used herein is not limited to ones for distribution, but includes storage media such as a magnetic disk and a semiconductor memory provided inside the computer or provided in equipment connected via a network.

Note that the present invention is not limited to the above embodiments, but various modifications can be made at the implementation stage within the range not deviating from the spirit. Further, the embodiments may be implemented in combination as appropriate, and the combined effects can be obtained in that case. Furthermore, the above embodiments include various inventions, and various inventions may be extracted based on combinations selected from the plurality of disclosed constituent features. For example, even when some constituent features are removed from all constituent features shown in the embodiments, a configuration in which these constituent features are removed may be extracted as an invention when the problem can be solved and the effects can be obtained.

### REFERENCE SIGNS LIST

10 Rule processing apparatus

11 Storage unit

11a Business data storage unit

11b Evaluation rule storage unit

12 Evaluation processing unit

12a Element evaluation value count unit

12b Rule evaluation value count unit

13 Evaluation result processing unit

13a Rule error count unit

14 Calculation unit

14a Ratio calculation unit

14b Hit rate calculation unit

15 Rule processing unit

15a Determination unit

15b Rule generation unit

15c Rule deletion unit

1. A rule processing apparatus comprising:
a processor; and
a storage medium having computer program instructions stored thereon, when executed by the processor, perform to:
evaluates, by comparing a plurality of business data to be evaluated with at least one first rule that is at least one rule used for evaluating whether business data is appropriate or not and at least one second rule that is at least one rule used for evaluating whether the business data is inappropriate or not that are stored in a storage apparatus in which the first and second rules are stored, whether or not the business data conforms to the first or second rule for each business data, and evaluates whether the business data is appropriate or not based on a result of the evaluation;
calculates a rule hit rate that is the proportion of the number of business data conforming to the first or second rule to the total number of the business data based on an evaluation result;
calculates a ratio that is based on the number of business data as conforming to the first rule among the plurality of business data to be evaluated and the number of business data as conforming to the second rule among the plurality of business data to be evaluated; and
a determination unit that determines that the first or second rule needs to be increased or decreased in number based on the rule hit rate and the ratio.

2. The rule processing apparatus according to claim 1, wherein the computer program instructions further perform to
determines that the first rule needs to be increased in number when the rule hit rate and the ratio are so low as to satisfy respective predetermined conditions,
determines that the second rule needs to be increased in number when the rule hit rate is so low as to satisfy a predetermined condition and the ratio is so high as to satisfy a predetermined condition,
determines that the first rule needs to be decreased in number when the rule hit rate and the ratio are so high as to satisfy respective predetermined conditions, and
determines that the second rule needs to be decreased in number when the rule hit rate is so high as to satisfy a predetermined condition and the ratio is so low as to satisfy a predetermined condition.

3. The rule processing apparatus according to claim 1, wherein
the business data includes a plurality of elements,
each of the first and second rules includes a rule corresponding to each of the plurality of elements of the business data, and the computer program instructions further perform to
compares each element of the business data with the rule corresponding to the element in the first and second rules, evaluates, for each element, whether or not the element of the business data conforms to the corresponding element in the first or second rule based on a result of this comparison, and evaluates, for each business data, whether or not the business data conforms to the first or second rule based on a result of this evaluation, and
counts, when the element of the business data is evaluated as conforming to the rule corresponding to the element in the first or second rule, an element evaluation value that is the number of the elements of the business data conforming to the evaluated element in the rule;
counts, when the business data is evaluated by as conforming to the first or second rule, a rule evaluation value that is the number of times of being evaluated as conforming to each of the first and second rules to which the business data is evaluated as conforming;
counts, when an evaluation result for the business data is evaluated by an evaluator as an error, the number of rule errors that is the number of errors of evaluation for each of the first and second rules to which the business data is evaluated by the evaluation unit as conforming;
when it is determined by that the first rule needs to be increased in number, extracts the rule having the smallest rule evaluation value counted among the at least one first rule and generates a new first rule in which a rule corresponding to the element having the smallest element evaluation value among the elements in this rule is a wild card, and when it is determined by the determination unit that the second rule needs to be increased in number, extracts the rule having the smallest rule evaluation value counted among the at least one second rule and generates a new second rule in which a rule corresponding to the element having the smallest element evaluation value counted among the elements in this rule is a wild card; and
when it is determined that the first rule needs to be decreased in number, deletes the rule with the largest number of rule errors counted among the at least one first rule, and when it is determined by the determination unit that the second rule needs to be decreased in number, deletes the rule with the largest number of rule errors counted among the at least one second rule.

4. The rule processing apparatus according to claim 3, wherein the computer program instructions further perform to compares each element of the business data with the rule corresponding to the element in the first and second rules, evaluates, for each element, whether or not the element of the business data conforms to the corresponding element in the first or second rule based on a result of this comparison, evaluates the business data as conforming to the compared first rule when all the elements of the business data conform to the corresponding elements in the compared first rule, and evaluates the business data as conforming to the compared second rule when all the elements of the business data conform to the corresponding elements in the compared second rule.

5. A rule processing method performed by a rule processing apparatus, the rule processing method comprising:
evaluating, by comparing a plurality of business data to be evaluated with at least one first rule that is at least one rule used for evaluating whether business data is appropriate or not and at least one second rule that is at least one rule used for evaluating whether the business data is inappropriate or not that are stored in a storage apparatus in which the first and second rules are stored, whether or not the business data conforms to the first or second rule for each business data, and evaluating whether the business data is appropriate or not based on a result of the evaluation;
calculating a rule hit rate that is the proportion of the number of business data conforming to the first or second rule to the total number of the business data based on a result of the evaluation;
calculating a ratio that is based on the number of the business data evaluated as conforming to the first rule among the plurality of business data to be evaluated and the number of the business data evaluated as conforming to the second rule among the plurality of business data to be evaluated; and
determining that the first or second rule needs to be increased or decreased in number based on the calculated rule hit rate and the calculated ratio.

6. A non-transitory computer-readable medium having computer-executable instructions that, upon execution of the instructions by a processor of a computer, cause the computer to function as the rule processing apparatus according to claim 1.
